(19) United States
(12) Patent Application Publication
(10) Pub. No.: US 2025/0287408 A1
(43) Pub. Date: Sep. 11, 2025

(54) DYNAMIC vDU SCALING IN EDGE CLUSTER USING CELL SIZE RESHAPING METHOD

(71) Applicant: Outdoor Wireless Networks LLC, Richardson, TX (US)

(72) Inventors: Gopinath Kommi, Bengaluru (IN); Purnima Venkata Kompella, Bangalore (IN); Prahlada Herle, Bangalore (IN)

(73) Assignee: Outdoor Wireless Networks LLC, Richardson, TX (US)

(21) Appl. No.: 19/072,622

(22) Filed: Mar. 6, 2025

Related U.S. Application Data
(60) Provisional application No. 63/562,065, filed on Mar. 6, 2024.

(51) Int. Cl. H04W 72/52

(52) U.S. Cl. CPC H04W 72/52

(57) ABSTRACT

The present disclosure describes techniques for dynamic virtual distributed unit (vDU) scaling in an edge cluster. In one aspect, a method comprises monitoring a capacity requirement of a geographical area having a plurality of cells being served by a corresponding plurality of vDUs. The capacity requirement comprises a Physical Resource Block (PRB) usage of the geographical area and a user equipment (UE) count being served in the geographical area. The method further comprises determining a number of vDUs required to cater the capacity requirement of the geographical area and adjusting a count of the plurality of VDUs based on the number of vDUs required. The adjusting of the count of the plurality of VDUs comprises increasing or decreasing the count of the plurality of VDUs.

### CROSS-REFERENCE TO RELATED APPLICATIONS

This application claims the benefit of U.S. Provisional Patent Application Ser. No. 63/562,065, filed on Mar. 6, 2024, titled “DYNAMIC vDU SCALING IN EDGE CLUSTER USING CELL SIZE RESHAPING METHOD”, which is hereby incorporated herein by reference in its entirety.

### TECHNICAL FIELD

The present disclosure in general relates to wireless communication. More particularly, but not exclusively, the present disclosure relates to techniques for dynamic virtual distributed unit (vDU) scaling for managing load.

### BACKGROUND

Cloud Radio Access Networks (C-RANs) are cloud-native, centralized cellular network architecture. C-RANs provide great benefits in network scalability and performance. C-RANs enhance radio networks through improvements in real-time virtualization and cloud computing to provide higher spectrum efficiency, faster RAN speeds, and support a larger number of mobile devices. C-RAN architecture plays a crucial role in transforming networks to support Fifth Generation (5G) technology. As cellular networks are growing larger, cloud RAN architecture aids to improve the demand for better coverage, reliability, and capacity.

The C-RAN is used to implement base station functionality for providing wireless service to various user equipment (UEs). In particular, cloud-based virtualization of 5G New Radio (NR) base stations (also referred to as a “gNodeBs” or “gNBs”) is widely promoted by standards corporations, wireless network operators, and wireless equipment vendors. Such an approach can help in providing better high-availability and scalability solutions as well as addressing other issues in the network. In general, a 5G gNB is typically partitioned into different entities, each of which can be implemented in different ways. For example, each entity can be implemented as a physical network function (PNF) or a virtual network function (VNF) and in different locations within an operator's network (for example, in the operator's “edge cloud” or “central cloud”).

A distributed 5G gNB can be partitioned into one or more central unit entities (CUs), one or more distributed unit entities (DUs), and one or more radio units (RUs). Since network functions are now virtualized and software-based, the wireless network can be made more scalable and flexible, with an ability to pool resources and dynamically allocate them whenever needed, as well as to re-use infrastructure for different applications. Typically, the CU and DU functions run as virtual software functions on standard commercial off-the-shelf (COTS) hardware and may be deployed in any RAN tiered data center. They can be deployed as virtual machines (VMs) or containers.

Enhanced small cell base stations have recently been introduced that can provide improved performance, particularly when dense deployment is required. An example of such an enhanced small cell system is the OneCell C-RAN Enterprise Small Cell system sold by CommScope, Inc. of Hickory, N.C., which is referred to herein as the “OneCell system.” OneCell is designed to service medium-sized to large buildings with high capacity and excellent performance. OneCell architecture is designed to scale independently in two dimensions: coverage dimension and capacity/throughput dimension.

However, the existing scaling solution is static, in the sense that at a given deployment site, computing resources required to satisfy the peak service demand are estimated at the time of installation and remain static thereafter. Also, mechanisms to right-size the computing resources dynamically and adapt to the actual service demand at the site is a challenge. Thus, the inability to dynamically adjust the computing resources results in higher operating costs (OPEX) for the operators.

The information disclosed in this background section is only for enhancement of understanding of the general background of the disclosure and should not be taken as an acknowledgement or any form of suggestion that this information forms the prior art already known to a person skilled in the art.

### SUMMARY

According to an aspect of the present disclosure, methods, apparatus, and computer readable media are provided for dynamic virtual distributed unit (vDU) scaling an edge cluster using cell size reshaping.

In one non-limiting aspect of the present disclosure, a method includes monitoring a capacity requirement of a geographical area having a plurality of cells being served by a corresponding plurality of virtual Distributed Units (vDUs). The capacity requirement comprises a Physical Resource Block (PRB) usage of the geographical area and a user equipment (UE) count being served in the geographical area. The method further includes determining a number of vDUs required to cater the capacity requirement of the geographical area and adjusting a count of the plurality of vDUs based on the number of vDUs required. The adjusting comprises increasing or decreasing the count of the plurality of VDUs.

In another non-limiting aspect of the present disclosure, an apparatus may comprise a memory, at least one transceiver, and at least one processor communicatively coupled with the memory and the at least one transceiver. The at least one processor is configured to monitor a capacity requirement of a geographical area having a plurality of cells being served by a corresponding plurality of virtual Distributed Units (vDUs). The capacity requirement comprises a Physical Resource Block (PRB) usage in the geographical area and a user equipment (UE) count being served in the geographical area. The at least one processor is further configured to determine a number of vDUs required to cater the capacity requirement of the geographical area and determine a number of vDUs required to cater the capacity requirement of the geographical area and adjust a count of the plurality of vDUs based on the number of vDUs required by increasing or decreasing the count of the plurality of vDUs.

In another non-limiting aspect of the present disclosure, a non-transitory computer readable media stores one or more instructions which, when executed by at least one processor, cause the at least one processor to perform operations of monitoring a capacity requirement of a geographical area having a plurality of cells being served by a corresponding plurality of virtual Distributed Units (vDUs), wherein the capacity requirement comprises a physical Resource Block (PRB) usage of the geographical area and a user equipment (UE) count being served in the geographical area, determining a number of vDUs required to cater the capacity requirement of the geographical area and adjusting a count of the plurality of VDUs based on the number of vDUs required, wherein the adjusting comprises increasing or decreasing the count of the plurality of VDUs.

The foregoing summary is illustrative only and is not intended to be in any way limiting. In addition to the illustrative aspects, aspects, and features described above, further aspects, aspects, and features will become apparent by reference to the drawings and the following detailed description.

### BRIEF DESCRIPTION OF DRAWINGS

Further aspects and advantages of the present disclosure will be readily understood from the following detailed description with reference to the accompanying drawings. Reference numerals have been used to refer to identical or functionally similar elements. The figures together with a detailed description below, are incorporated in and form part of the specification, and serve to further illustrate the aspects and explain various principles and advantages, in accordance with the present disclosure wherein:

FIG. 1 shows an exemplary aspect of a cloud radio access network (C-RAN) communication system 100, in accordance with some aspects of the present disclosure.

FIG. 2a shows a high-level block diagram of a small cell 5G (SA) gNB system with reduced load condition, in accordance with some aspects of the present disclosure.

FIG. 2b shows a high-level block diagram of a small cell 5G (SA) gNB system with increased load condition, in accordance with some aspects of the present disclosure.

FIG. 3 shows a high-level block diagram of an apparatus 300 where the dynamic vDU scaling technique consistent with the present disclosure may be implemented, in accordance with some aspects of the present disclosure.

FIG. 4 shows a flowchart of an exemplary method 400 of dynamic vDU scaling in a small cell 5G (SA) gNB system, in accordance with some aspects of the present disclosure.

FIG. 5 shows a flowchart of another exemplary method 500 of dynamic vDU scaling during a low load scenario, in accordance with some aspects of the present disclosure.

FIG. 6 shows a flowchart of yet another exemplary method 600 of dynamic vDU scaling during peak load scenario, in accordance with some aspects of the present disclosure.

It should be appreciated by those skilled in the art that any block diagrams herein represent conceptual views of the illustrative systems embodying the principles of the present disclosure. Similarly, it will be appreciated that any flowcharts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration.” Any aspect or implementation of the present disclosure described herein as “exemplary” is not necessarily to be construed as preferred or advantageous over other aspects.

While the disclosure is susceptible to various modifications and alternative forms, specific aspects thereof have been shown by way of example in the drawings and will be described in detail below. It should be understood, however, that it is not intended to limit the disclosure to the particular form disclosed, but on the contrary, the disclosure is to cover all modifications, equivalents, and alternatives falling within the spirit and the scope of the disclosure.

The terms “comprise(s)”, “comprising”, “include(s)”, or any other variations thereof, are intended to cover a non-exclusive inclusion, such that a setup, device, apparatus, system, or method that comprises a list of components or steps does not include only those components or steps but may include other components or steps not expressly listed or inherent to such setup or device or apparatus or system or method. In other words, one or more elements in a device or system or apparatus preceded by “comprises . . . a” does not, without more constraints, preclude the existence of other elements or additional elements in the system.

The terms like “at least one” and “one or more” may be used interchangeably throughout the description. The terms like “a plurality of” and “multiple” may be used interchangeably throughout the description. The terms like “distributed unit”, “distributed unit entity” and “DU” may be used interchangeably throughout the description. The terms like “central unit control plane”, “CU-CP”, “CU-CP entity”, and “vCU-CP” may be used interchangeably throughout the description. The terms like “central unit user plane”, “CU-UP”, “CU-UP entity” and “vCU-UP” may be used interchangeably throughout the description. The terms like “vDU”, and “virtual distributed unit” may be used interchangeably throughout the description. The terms like “COTS” and “commercial off the shelf server” may be used interchangeably throughout the description. The terms like “network operator”, “operator”, and “service provider” may be used interchangeably throughout the description. The terms like “geographical area” and “tracking area” may be used interchangeably throughout the description. The terms like “capacity requirement”, “load” and “demand” may be used interchangeably throughout the description.

In the following detailed description of the aspects of the disclosure, reference is made to the accompanying drawings that form a part hereof, and in which are shown by way of illustration of specific aspects in which the disclosure may be practiced. These aspects are described in sufficient detail to enable those skilled in the art to practice the disclosure, and it is to be understood that other aspects may be utilized and that changes may be made without departing from the scope of the present disclosure. The following description is, therefore, not to be taken in a limiting sense. In the following description, well known functions or constructions are not described in detail since they would obscure the description with unnecessary detail.

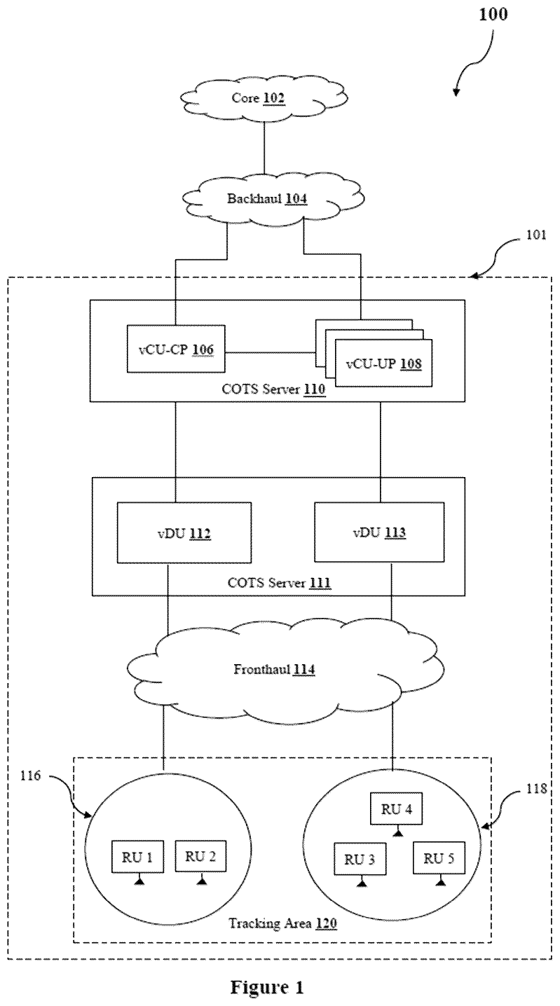

Referring now to FIG. 1 which shows an exemplary aspect of a cloud radio access network (C-RAN) communication system 100 comprising a 5G New Radio (NR) base station system (also referred to as a “gNodeB” or “gNB”) 101 or OneCell 5G gNB system 101 or a small cell 5G SA gNB system 101, in accordance with some aspects of the present disclosure. Although FIG. 1 is described in the context of a 5G architecture in which the base station is partitioned into one or more CUs, one or more DUs, and one or more RUs and some physical-layer processing is performed in the DUs with the remaining physical-layer processing being performed in the RUs, it is to be understood that the techniques described here can be used with other wireless interfaces for example, 4G LTE. The gNB 101 may be configured to provide wireless services to the at least one user equipment (UE) present in a wireless coverage area/tracking area 120 or cells 116 or 118 served by the gNB 101. However, the number of cells and tracking area is not limited to the above example and gNB 101 may comprise more than two cells providing coverage over one or more tracking areas.

The at least one UE may be any mobile or non-mobile computing device including, but not limited to, a phone (e.g., a cellular phone or smart phone), a pager, a laptop computer, a desktop computer, a wireless handset, a portable communication device, a portable computing device (e.g., a personal data assistant), an entertainment device (e.g., a music or video device, or a satellite radio), a global positioning system device, or any other suitable computing device including a wired or wireless communications interface. In some aspects of the present disclosure, the at least one UE may be Internet-of-Things (IoT)-enabled device including, but not limited to, vehicles configured to communicate with the gNB 101 or a core network.

The gNB 101 may be partitioned into a central unit (CU), a distributed unit (DU), and one or more radio units (RUs). In such a configuration, the CU is configured to serve the DU and the DU is configured to serve the one or more RUs. In the aspect of FIG. 1, the CU may be further partitioned into a control-plane entity (CU-CP) 106 and one or more user-plane entities (CU-UP) 108 that may handle the control-plane and user-plane processing of the CU, respectively. In one non-limiting aspect, the CU and DU functions may run as virtual software functions on standard commercial off-the-shelf (COTS) server 110 and 111. In such a case, the CU-CP entity 106 may also be referred to as a “vCU-CP” 106 and each such user-plane CU entity 108 may also be “vCU-UP” 108. The vCU-CP 106 and vCU-UP 108 entities may be interconnected through an interface specified by the relevant 3GPP 5G NR Technical Specifications. The vCU-CP 106 and vCU-UP entity 108 may be communicatively coupled with a plurality of virtual DUs (vDUs) such a vDU 112 and vDU 113 via an interface known to a person skilled in the art. In one non-limiting aspect, each of the plurality of virtual DUs 112 and 113 may be hosted on the same COTS server 110 or on a different COTS server 111.

In such an example, the vCU-CP 106 and vCU-UP entity 108 may be configured to communicate with a core network 102 of an associated wireless operator using an appropriate backhaul network 104 (typically, a public wide area network such as the Internet). In one non-limiting aspect of the present disclosure, the core network 102 may be a 5G core network in a standalone mode of deployment. The 5G core network may utilize cloud-aligned, service-based architecture that spans across all 5G functions and interactions including authentication, security, session management etc. The 5G core network may further emphasize network function virtualization (NFV) as an integral design concept with virtualized software functions.

In another non-limiting aspect, the core network 102 may be a long-term evolution evolved packet core (LTE EPC) network in a non-standalone mode of deployment where services are provided using previous generation infrastructure (e.g., using existing LTE Evolved Packet Core (EPC)). In non-standalone deployment, an interface S1 may exist between the gNB 101 and the LTE EPC. The present disclosure may also be applicable for standalone and/or non-standalone modes of deployments or other modes of deployments which may be developed in the future.

In one implementation (as shown in FIG. 1), each RU (RU1, RU2, RU3, RU4, RU5) may be remotely located from the vDUs 112 serving it, e.g., the RU1 and RU2 may be deployed in a first cell 116 and RU3, RU4, and RU5 may be deployed in a second cell 118. In one non-limiting aspect, the first cell 116 and the second cell 118 are present with a predetermined geographical area or tracking area 120. Each RU may be communicatively coupled to a respective vDU 112 of the plurality of vDUs, which is serving it via a fronthaul network 114 which may comprise a private network, and/or the Internet, but not limited thereto. Also, each RU may include or may be coupled to a respective set of one or more antennas via which downlink (DL) RF signals are radiated to the UEs served within the first cell 116 and the second cell 118 and via which uplink (UL) RF signals transmitted by the UEs are received.

In an aspect of the present disclosure, the small cell 5G SA gNB system 101 may comprise the first cell 116 having the radio units RU1 and RU2 serving one or more UEs present within the first cell 116, and the second cell 118 having the radio units RU3, RU4, and RU5 serving one or more UEs present within the second cell 118. Both the first cell 116 and the second cell 118 may belong to the same predetermined geographical area or tracking area 120. In one aspect, each of the first cell 116 and the second cell 118 may be served by a different vDU out of the plurality of vDUs 112 hosted on a COTS server 110 consuming the computing resources on it.

In an aspect of the present disclosure, a capacity requirement of a geographical area or the tracking area 120 is monitored by a RAN Intelligent Controller (RIC) (not shown). The capacity requirement may be monitored by determining at least Physical Resource Block (PRB) usage of the tracking area 120 and a user equipment (UE) count being served in the tracking area 120. However, the capacity requirement is not limited to the above example and may comprise any other parameters that determine capacity need of the tracking area 120. Based on the capacity requirement, a number of vDUs 112 required to cater the capacity requirement of the geographical area 120 is determined and the count of the vDUs 112 is adjusted based on the number of vDUs required. Here, the adjustment means either increasing or decreasing the count of the current number of vDUs being utilized for serving the geographical region. Thus, only the determined or required number of vDUs 112 are implemented through the COTS server 110 based on the demand of computing resources in the gNB 101, thereby implementing dynamic vDU scaling in the gNB 101.

Each of the CU having vCU-CP entity 106, vCU-UP entity 108, vDU 112, RU and any of the specific features described herein can be implemented in hardware, software, or combinations of hardware and software, and the various implementations (whether hardware, software, or combinations of hardware and software) can also be referred to generally as “circuitry,” a “circuit,” or “circuits” that is or are configured to implement at least some of the associated functionality. When implemented in software, such software can be implemented in software or firmware executing on one or more suitable programmable processors (or other programmable device) or configuring a programmable device (for example, processors or devices included in or used to implement special-purpose hardware, general-purpose hardware, and/or a virtual platform). In such a software example, the software can comprise program instructions that are stored (or otherwise embodied) on or in an appropriate non-transitory storage medium or media (such as flash or other non-volatile memory, magnetic disc drives, and/or optical disc drives) from which at least a portion of the program instructions are read by the programmable processor or device for execution thereby (and/or for otherwise configuring such processor or device) in order for the processor or device to perform one or more functions described here as being implemented the software. Such hardware or software (or portions thereof) can be implemented in other ways (for example, in an application specific integrated circuit (ASIC), etc.).

Moreover, each the CU having vCU-CP entity 106 and vCU-UP entity, vDU 112, and RU 108 may be implemented as a physical network function (PNF) (for example, using dedicated physical programmable devices and other circuitry) and/or a virtual network function (VNF) (for example, using one or more general purpose servers (possibly with hardware acceleration) in a scalable cloud environment and in different locations within an operator's network (for example, in the operator's “edge cloud” or “central cloud”). Each VNF can be implemented using hardware virtualization, operating system virtualization (also referred to as containerization), and application virtualization as well as various combinations of two or more the preceding. Where containerization is used to implement a VNF, it may also be referred to as a “containerized network function” (CNF).

The scalable cloud environment can be implemented in a distributed manner within a distributed scalable cloud environment comprising at least one central cloud and at least one edge cloud. For example, in the exemplary aspect shown in FIG. 1, each RU is implemented as a PNF and is deployed in or near a physical location where radio coverage is to be provided and the CU having vCU-CP entity 106, vCU-UP entity 108, vDU 112, and RU are implemented using a respective set of one or more VNFs deployed in a distributed manner within one or more clouds (for example, within an “edge” cloud or “central” cloud). However, the present disclosure is not limited thereto, and each of the CU having vCU-CP entity 106, vCU-UP entity 108, vDU 112, RU, and any of the specific features described here as being implemented thereby, can be implemented in other ways.

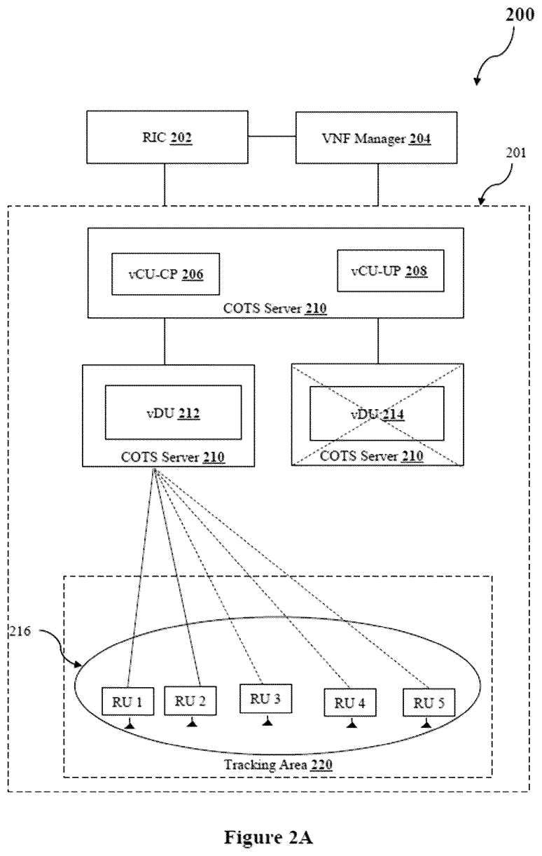

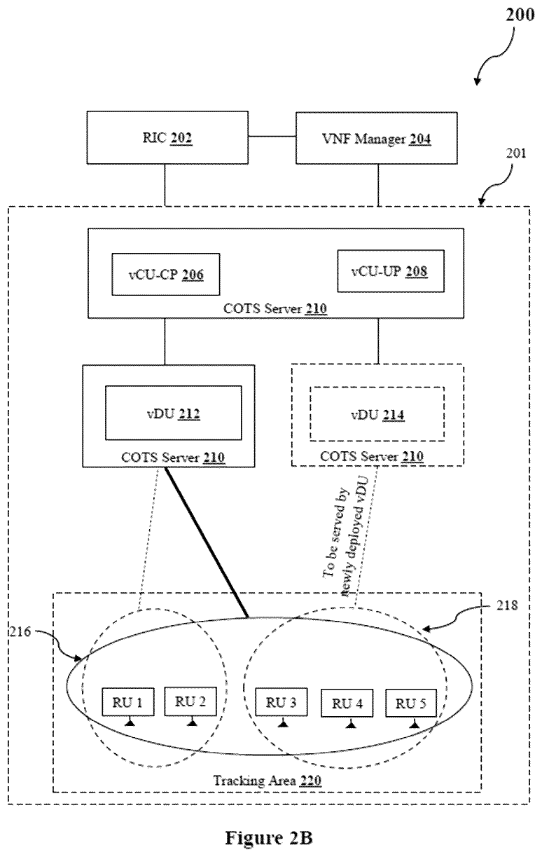

Referring now to FIG. 2A which shows a high-level block diagram of a small cell 5G (SA) gNB system 200 comprising gNB 201, in accordance with an aspect of present disclosure. The gNB 201 may be managed by a RAN Intelligent controller (RIC) 202 and a Virtual Network Function (VNF) Manager 204. The gNB 201 may be configured to provide wireless services/5G cellular services to one or more items of user equipment (UE) present in a wireless coverage area/tracking area 220. The tracking area 220 may comprise two cells i.e., a first cell 216 and a second cell 218. However, the number of cells in the tracking area 120 is not limited to the above example and the tracking area 120 may comprise more than two cells. In one non-limiting aspect, the present concept is only applicable to cells belonging to the same tracking area 120.

The gNB 201 may comprise a virtual central unit control plane entity (vCU-CP) 206 and a virtual central unit user plane entity (vCU-UP) 208 that may be hosted on a COTS server 210. In one non-limiting aspect, the number of vCU-CP 106 and vCU-UP 108 may vary based on a demand or a capacity requirement. The gNB 201 may further comprise two virtual distributed units vDUs 212 and 214 for catering the capacity requirement in the tracking area 220. The vDU 212 and vDU 214 may be hosted on a COTS server 210. In one no-limiting aspect, the vDU 212 and the vDU 214 may be hosted on different COTS servers. The vDU 212 may be mapped to serve the first cell 216 and the vDU 214 may be mapped to serve the second cell 216. The vDU 212 may be configured to serve RU1 and RU2 present in the first cell 216 and the vDU 214 may be configured to serve RU3, RU4, and RU5 present in the second cell 218.

In an aspect of the present disclosure, the vDU 212 and the vDU 214 may be deployed by the VNF Manager 204. The RIC 202 and the VNF Manager 204 may configure a whitelist of the vDU 212 by including serial numbers of RU1 and RU2 such that RU1 and RU2 from the first cell 216 are homed to vDU 212 and a whitelist of the vDU 214 by including serial numbers of RU3, RU4, and RU5 such that RU3, RU4, and RU5 from the second cell 218 are homed to vDU 214. Each of the vDU 212 and the vDU 214 may be configured to update the RIC 202 with one or more parameters such as physical cell identifier (PCI), a tracking area, a maximum available physical resource blocks (PRBs), a maximum UE count capacity, a neighbour List, and a whitelist information. During runtime, each of the vDU 212 and the vDU 214 may be configured to periodically transmit a current PRB usage, connected UEs count, and neighbour list to the RIC 202 for monitoring a load status of each vDU.

In an aspect of the present disclosure, the RIC 202 may be configured to create and maintain a list of vDUs belonging to the same tracking area. In such a scenario, the list may comprise vDU 212 and vDU 214 belonging to the same tracking area 220. During the runtime, the RIC 202 may be configured to periodically receive a current PRB usage, connected UEs count, and neighbour list from each of the vDU 212 and the vDU 214. The current PRB usage indicates the number of resource blocks currently being used for actual transmission and reception. The connected UEs count may indicate a number of user equipment (UEs) currently being served through the vDU i.e., vDU 212 and the vDU 214. The neighbour list may comprise a list of cells served within the same gNB 201 and are part of the same tracking area. Thus, the RIC 202 knows about the neighbour list of each vDU with periodic updates. Also, when 2 vDUs are subsumed to only a single selected vDU due to decrease in load/demand in that geographical area, RIC can upfront populate selected vDU with neighbors that were discovered by UEs of terminated vDU. This way, when the selected vDU takes over the geographical area, it can make handover decisions easily (without having to discover neighbors once again via the UEs that move to the selected vDU from the terminated vDU. The RIC 202 may be continuously monitoring a load status of each of the vDU 212 and the vDU 214. The load status may comprise a PRB usage of each of the vDU 212 and the vDU 214, and a UE count being served by each of the vDU 212 and the vDU 214.

The RIC 202 may be configured to compare a total PRB usage across the vDU 212 and the vDU 214 with the maximum available PRB in one of the vDU 212 and the vDU 214 and compare a total connected UEs count of the vDU 212 and the vDU 214 with a maximum UE count capacity of one of vDU 212 and the vDU 214. If the total PRB usage is less than the maximum available PRB for a predetermined time period, and the total connected UEs count is less than the maximum UE count capacity for the predetermined time period, the RIC 202 may be configured to select one vDU out of the vDUs i.e., vDU 212 and the vDU 214 for serving the cells 216 and 218. In other words, the RIC 202 will understand that currently the load on the vDUs is less, and therefore only one vDU can handle the entire load. Thus, the other vDU (in this example anyone of vDU 212 and vDU 214) can be terminated and the resources released by the terminated vDU may be used for some other purpose.

As shown in FIG. 2A, the vDU 212 is selected to serve both the cells 216 and 218. The vDU 214 remaining after selection may be terminated/collapsed. The termination of the vDU 214 may comprise releasing of the vDU 214 by barring an access to cell 218 (served by vDU 214) through system information broadcast update and merging the cells 216 and 218 to form a single cell 216. At the time of termination of vDU 214, the RIC 202 may begin the RU re-homing process for the RUs connected to the vDU 214. In the RU re-homing process, the RUs (RU3, RU4, and RU5) of the vDU 214 are directed to the vDU 212. The RU3, RU4, and RU5 are allocated to the vDU 212 by updating the whitelist of the vDU 212 to include the serial numbers of the RU3, RU4, and RU5. The whitelist of the vDU 214 may be erased by deleting the serial numbers of the RU3, RU4, and RU5. The deletion of the whitelist forces the RU3, RU4, and RU5 to initiate rehoming procedure and the RUs get homed to the vDU 212 (shown in dotted line). After all the RUs (RU3, RU4, and RU5) are homed to the vDU 212, the VNF manager 204 may shutdown the vDU 214. The shutdown of vDU 214 facilitates freeing up of the computing resources of the cloud pool of the COTS server 210, thereby reducing the operational costs under low load condition. In one non-limiting aspect, RUs of vDU 214 (the one which is going down) are abruptly re-homed to vDU 212 via RIC changing the whitelist of vDU 212 and 214. In such a case, cell-barring using system information broadcast is not needed in vDU 214. UEs that were being served by vDU 214 so far will declare radio link failure (RLF). These UEs will start the cell-selection/reselection procedure. Once RUs of vDU 214 get re-homed successfully to vDU 212, they will transmit the new cell 216s′ information. UEs cell-selection will succeed at this stage, and they proceed for a fresh connection on cell 216 of vDU 212.

However, there could be a contrary scenario where the existing vDUs serving the geographical region might face a surge in the load due to the increase in the number of user equipment or due to increase in data requirement or any other reasons. In such the scenario, the RIC 202 will have to identify the suitable one or more vDUs and add them with the existing set of vDUs for catering the demand. This scenario is explained in upcoming paragraphs using FIG. 2B.

Referring now to FIG. 2B that shows a high-level block diagram of a small cell 5G (SA) gNB system 200 comprising gNB 201, in accordance with an aspect of present disclosure. The gNB 201 may be managed by a RAN Intelligent controller (RIC) 202 and a Virtual Network Function (VNF) Manager 204. The gNB 201 may be configured to provide wireless services/5G cellular services to one or more items of user equipment (UEs) present in a wireless coverage area/tracking area 220. The tracking area 220 may comprise only cell i.e., cell 216.

The gNB 201 may comprise a virtual central unit control plane entity (vCU-CP) 206 and a virtual central unit user plane entity (vCU-UP) 208 that may be hosted on a COTS server 210. In one non-limiting aspect, the number of vCU-CP 106 and vCU-UP 108 may vary based on the demand or the capacity requirement. The gNB 201 may further comprise a virtual distributed unit vDUs 212 for catering the capacity requirement in the tracking area 220. The vDU 212 may be hosted on a COTS server 210. The vDU 212 may be mapped to serve the cell 216. The vDU 212 may be configured to serve RU1, RU2, RU3, RU4, and RU5 for the cell 216.

In an aspect of the present disclosure, the vDU 212 may be deployed by the VNF Manager 204. The RIC 202 and the VNF Manager 204 may configure a whitelist of the vDU 212 by including serial numbers of RU1, RU2, RU3, RU4, and RU5 such that RU1, RU2, RU3, RU4, and RU5 from the cell 216 are homed to vDU 212. The vDU 212 may be configured to update the RIC 202 with one or more parameters such as physical cell identifier (PCI), a tracking area, a maximum available physical resource blocks (PRBs), a maximum UE count capacity, a neighbour List, and a whitelist information. During runtime, the vDU 212 may be configured to periodically transmit a current PRB usage, connected UEs count, and neighbour list to the RIC 202 for monitoring a load status of vDU 212.

In an aspect of the present disclosure, the RIC 202 may be continuously monitoring a load status of the vDU 212. The load status may comprise a PRB usage of the vDU 212, and a UE count being served by the vDU 212. The RIC 202 may be configured to compare a PRB usage demand of the vDU 212 with the maximum available PRB available in the vDU 212 and compare a total connected UEs count of the vDU 212 with a maximum UE count capacity of the vDU 212. If the total PRB usage is greater than the maximum available PRB for a predetermined time period, and the total connected UEs count is greater than the maximum UE count capacity for the predetermined time period, the RIC 202 may be configured to deploy a new vDU 214 for serving the cell 216. In other words, the RIC 202 will understand that currently the load on the vDU 212 is more, and therefore a new vDU 214 is required to handle the current load.

As shown in FIG. 2B, the deployment of new vDU 214 may be carried out through a virtual network function (VNF) manager 204 from the commercial off the shelf (COTS) server 210. The cell 216 may split into two cells to create a new cell 218. The newly created cell 218 may be served by new vDU 214. Then, the RU re-homing of one or more RUs from the existing vDU 212 to the newly deployed vDU 214 is carried out. A whitelist of the new vDU 214 may be updated by the RIC 202 to include serial numbers of the one or more RUs (RU3, RU4, and RU5) from the exiting vDU 212 and the serial numbers of the one or more RUs (RU3, RU4, and RU5) may be deleted from the whitelist of the exiting vDU 212. Thus, the updating of the whitelist of the new vDU 214 facilitates RU-re-homing of RUs previously served by the existing vDU 212. The RU3, RU4, and RU5 may now become a part of the newly created cell 218, which will be served by the newly deployed vDU 214. In this aspect, when RUs (RU3, RU4, and RU5) broadcast cell 218 information, UEs under these RUs will automatically find the newly created cell 218 of vDU 214 to be stronger than their current service cell 216. And hence, these UEs will make a fresh connection or will handover to the new cell 218. Thus, the deployment of new vDU 214 (computed resources hosted on COTS server 210) facilitates management of load or a capacity requirement during peak load condition, thereby ensuring quality of services for the user equipment served by the gNB 201.

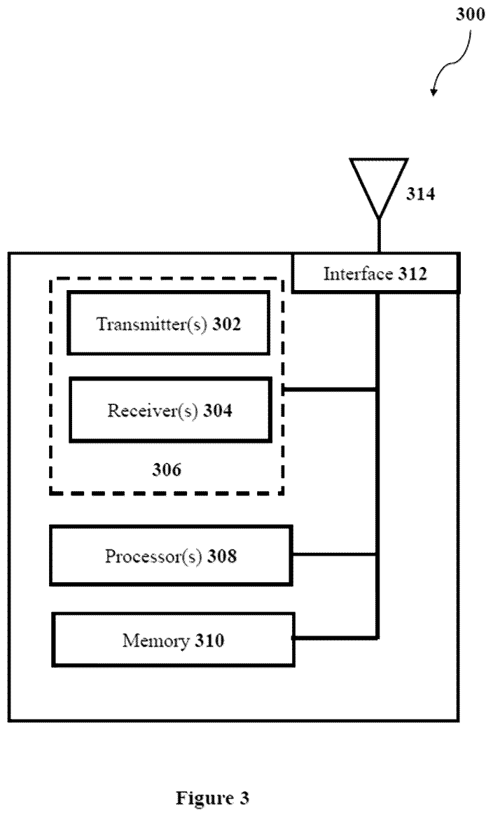

Referring now to FIG. 3 which illustrates a block diagram of an apparatus 300 where the dynamic vDU scaling technique is implemented, in accordance with some aspects of the present disclosure. The apparatus 300 may comprise at least one transmitter 302, at least one receiver 304, at least one processor 308, at least one memory 310, at least one interface 312, and at least one antenna 314. The at least one transmitter 302 may be configured to transmit data/information to one or more entities using the antenna 314 and the at least one receiver 304 may be configured to receive data/information from the one or more nodes/devices using the antenna 314. The at least one transmitter and receiver may be collectively implemented as a single transceiver module 306. In one non-limiting aspect, the at least one processor 308 may be communicatively coupled with the transceiver 306, memory 310, interface 312, and antenna 314 for implementing the above-described dynamic vDU scaling technique.

The at least one processor 308 may include, but not restricted to, microprocessors, microcomputers, micro-controllers, central processing units, state machines, logic circuitries, and/or any devices that manipulate signals based on operational instructions. A processor may also be implemented as a combination of computing devices, e.g., a combination of a plurality of microprocessors or any other such configuration. The at least one memory 310 may be communicatively coupled to the at least one processor 308 and may comprise various instructions for executing the dynamic vDU scaling technique. The at least one memory 310 may include a Random-Access Memory (RAM) unit and/or a non-volatile memory unit such as a Read Only Memory (ROM), optical disc drive, magnetic disc drive, flash memory, Electrically Erasable Read Only Memory (EEPROM), a memory space on a server or cloud and so forth. The at least one processor 308 may be configured to execute one or more instructions stored in the memory 310.

The interfaces 312 may include a variety of software and hardware interfaces, for example, a web interface, a graphical user interface, an input device-output device (I/O) interface, a network interface and the like. The I/O interfaces may allow the apparatus 300 to communicate with one or more nodes/devices either directly or through other devices. The network interface may allow the apparatus 300 to interact with one or more networks either directly or via any other network.

In one non-limiting aspect, the apparatus 300 may be a part of the RIC 202 but not limited thereto.

The at least one processor 308 may be configured to monitor a capacity requirement of a geographical area having a plurality of cells being served by a corresponding plurality of virtual Distributed Units (vDUs). The capacity requirement may comprise a Physical Resource Block (PRB) usage of the geographical area and a user equipment (UE) count being served in the geographical area. However, the capacity requirement is not limited to above parameters and any other parameter that contributes to the determination of capacity requirement of the vDUs is well within the scope of present disclosure. In one non-limiting aspect, the at least one transceiver 306 may receive physical cell ID (PCI), tracking area, maximum available PRBs, maximum connected UEs count, neighbour list, whitelist information from the plurality of vDU during deployment.

The at least one processor 308 may be configured to determine a number of vDUs required to cater the capacity requirement of the geographical area and adjust a count of the plurality of VDUs based on the number of vDUs required. The geographical area may be similar to the tracking area as discussed in above aspects. The adjustment may involve the at least one processor 308 increasing or decreasing the count of the plurality of vDUs.

To decrease the count of the plurality of vDUs, the at least one processor 308 may be configured to monitor a load status in each vDU, the load status comprising a PRB usage of each vDU and a UE count being served by each vDU. The load status of each of the plurality of vDU may be periodically received by the apparatus 300 from the respective vDUs. The at least one processor 308 may be then configured to compare a total PRB usage across at least two vDUs with a maximum available PRB in at least one vDU and compare a total connected UEs count of the at least two vDUs with a maximum UE count capacity of the at least one vDU. If there are ‘N’ number of vDUs currently present or deployed in a gNB, then the total PRB usage across ‘N’ vDUs is compared with maximum available PRB of ‘M’ vDUs and the total connected UEs count of the ‘N’ vDUs is compared with maximum UE count capacity of ‘M’ vDUs, where M is less than N. This comparison is carried out to check whether the current load of the ‘N’ vDUs may be managed through a lesser number of vDUs.

If the total PRB usage of ‘N’ vDUs is less than the maximum available PRB of ‘M’ vDUs for a predetermined time period, and the total connected UEs count of ‘N’ vDUs is less than the maximum UE count capacity of ‘M’ vDUs for the predetermined time period, ‘M’ vDUs out of the ‘N’ vDUs are selected for serving the one or more cells previously served by the ‘N’ vDUs. In such a scenario, the remaining ‘N-M’ vDUs are released by barring an access to corresponding one or more cells through system information broadcast update. This may be carried out through cell barred or cell reservation technique. The release of the ‘N-M’ vDUs may require the at least one processor 308 to merge at least two cells out of the ‘N’ cells to form a merged cell and the merged cell may be served by one of the selected ‘M’ vDUs. In one non-limiting aspect, the predetermined time period may be considered in such a manner to avoid quick hopping of RUs from one vDU to another. Further, the merging of one cell with another in the same tracking area or geographical area facilitates reduction in intercell interference.

The release of the ‘N-M’ vDUs may require the at least one processor 308 to allocate one or more radio units (RUs) of the ‘N-M’ vDUs to the one or more selected ‘M’ vDUs by updating a whitelist of the one or more selected vDUs i.e., ‘M’ vDUs to include serial numbers of the one or more RUs of the ‘N-M’ vDUs, and deleting the serial numbers of the one or more RUs from one or more whitelists of the ‘N-M’ vDUs to facilitate RU re-homing as discussed in above aspects. Once the RU of the ‘N-M’ vDUs are re-homed to one or more ‘M’ vDUs, the at least one processor 308 may be configured to terminate the ‘N-M’ vDUs.

In an aspect of the present disclosure, to increase the number of vDUs present in the geographical area, the at least one processor 308 may be configured to monitor a load status in each vDU. The at least one processor 308 may be then configured to compare a total PRB usage across at least one vDU with a maximum available PRB in the at least one vDU and compare a total connected UEs count of the at least one vDU with a maximum UE count capacity of the at least one vDU. For example, if there are ‘N’ number of vDUs currently present or deployed in a gNB, then the total PRB usage across ‘N’ vDUs is compared with maximum available PRB of ‘N’ vDUs and the total connected UEs count of the ‘N’ vDUs is compared with maximum UE count capacity of ‘N’ vDUs. This comparison is carried out to check whether the ‘N’ vDUs are overloaded or overburdened and whether there is a need to deploy an additional vDU for managing the load of the gNB.

If the total PRB usage is greater than the maximum available PRB for a predetermined time period and the total connected UEs count is greater than the maximum UE count capacity for the predetermined time period, the at least one processor 308 may deploy at least one new vDU in the same geographical area. The deployment may be carried out through a virtual network function (VNF) manager from the commercial off the shelf (COTS) server. The at least one processor 308 may also split at least one cell served by the at least one vDU to create at least one new cell and the at least one new cell is served by the at least one new vDU.

After the deployment of the at least one new vDU, the at least one processor 308 may carry out the RU re-homing of one or more RUs from the existing vDUs to the newly deployed vDU. The allocation may require the at least one processor 308 to configure a whitelist of the at least one new vDU to include serial numbers of the one or more RUs from the exiting vDUs and delete the serial numbers of the one or more RUs from a whitelist of the exiting vDUs. Thus, the configuration of the whitelist of the at least one new vDU facilitates RU-re-homing of RUs previously served by the existing vDUs, thereby adjusting the load of the existing vDU.

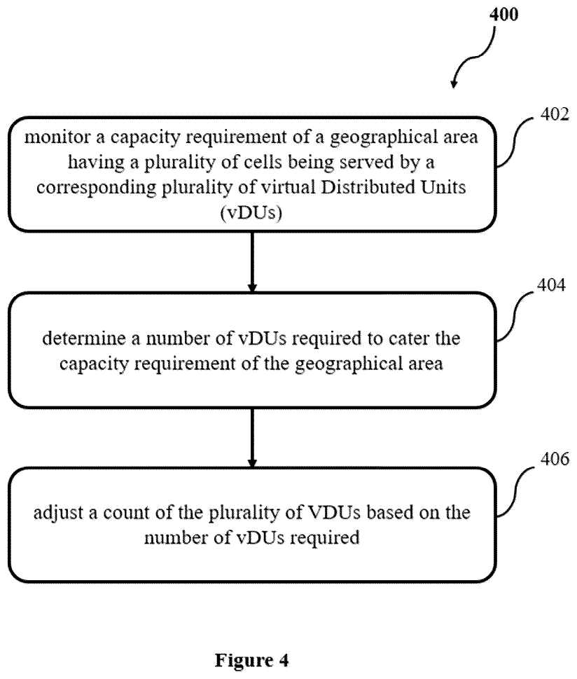

Referring now to FIG. 4, a flowchart is described illustrating an exemplary method 400 of dynamic vDU scaling, according to an aspect of the present disclosure. The method 400 is merely provided for exemplary purposes, and aspects are intended to include or otherwise cover any dynamic vDU scaling methods or procedures.

The method 400 may include, at block 402, monitoring a capacity requirement of a geographical area having a plurality of cells 216 and 218 being served by a corresponding plurality of virtual Distributed Units (vDUs) 212 and 214. For example, the capacity requirement may comprise a Physical Resource Block (PRB) usage of the geographical area and a user equipment (UE) count being served in the geographical area 220. The capacity requirement may be determined based on a plurality of parameters received from the plurality of vDUs 212 and 214. The plurality of parameters may at least comprise PRB usage, connected UEs count, and neighbour list of respective vDU 212 and 214.

At block 404, the method 400 may include determining a number of vDUs required to cater the capacity requirement of the geographical area 220. The at least one processor may receive physical cell ID (PCI), tracking area, maximum available PRBs, maximum connected UEs count, neighbour list, whitelist information from the plurality of vDU 212 and 214 instances during deployment. This information may be compared with the capacity requirement to determine the number of vDUs required to cater the capacity requirement of the geographical area 220.

At block 406, the method 400 may include adjusting a count of the plurality of vDUs based on the determination of the number of vDUs required. For example, the at least one processor may be increasing or decreasing the count of the plurality of vDUs. In case the number of vDUs required are greater than the existing number of vDUs, the RIC 202 may instruct the VNF Manager 204 to deploy one or more new vDUs from the commercial off the shelf (COTS) server 210. Thus, the deployment of the one or more new vDUs (computed resources hosted on COTS server 210) facilitates management of load or capacity requirement during peak load condition, thereby ensuring quality of services for the user equipment served by the gNB 201.

In case the number of vDUs required is less than the existing number of vDUs, then the RIC 202 may instruct the VNF Manager 204 to collapse/release/terminate one or more vDUs from the existing vDUs active in the gNB 201. Thus, the method 400 enables dynamic scaling of vDUs to cater the capacity requirement. The shutdown of vDU 214 facilitates freeing up of the computing resources of the cloud pool of the COTS server 210, thereby reducing the operational costs under low load condition. Further, the dynamic scaling of vDUs is done without invoking any RAN configuration change. In addition, the released vDU or computing resources may be used by any other gNB based on their capacity requirement.

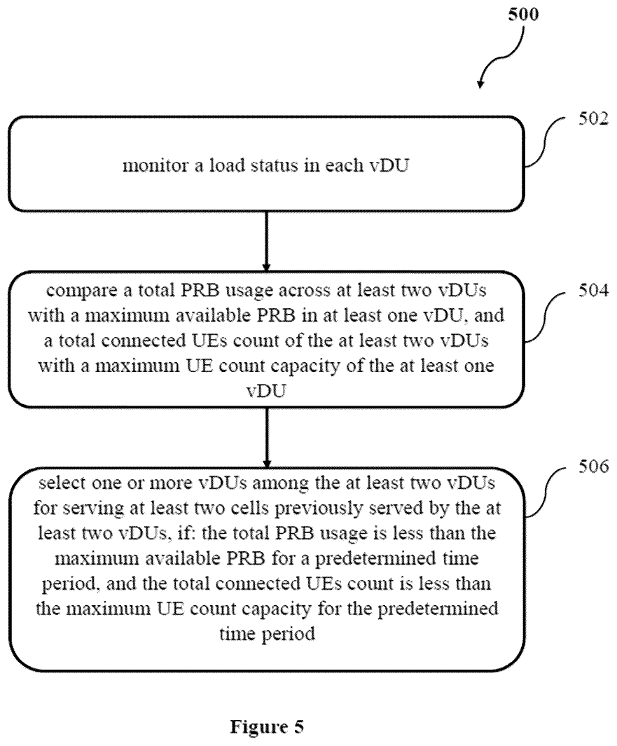

Referring now to FIG. 5, a flowchart is described illustrating another exemplary method 500 of dynamic vDU scaling during low load scenario, according to an aspect of the present disclosure. The method 500 is merely provided for exemplary purposes, and aspects are intended to include or otherwise cover any load balancing methods or procedures.

The method 500 may include, at block 502, monitoring a load status in each vDU 212 and 214. The load status may comprise a PRB usage of each vDU and a UE count being served by each vDU 212 and 214. The load status of each of the vDU 212 and 214 may be monitored based on the periodic receipt of a plurality of parameters from the plurality of vDUs 212 and 214. The plurality of parameters may at least comprise PRB usage, connected UEs count, and neighbour list.

At block 504, the method 500 may include comparing a total PRB usage across at least two vDUs 212 and 214 with a maximum available PRB in at least one vDU and comparing a total connected UEs count of the at least two vDUs 212 and 214 with a maximum UE count capacity of the at least one vDU. The maximum available PRB and the maximum UE count capacity may be received from the respective vDU at the time of deployment. If there are ‘N’ number of vDUs currently present or deployed in a gNB, then the total PRB usage across ‘N’ vDUs is compared with maximum available PRB of ‘M’ vDUs and the total connected UEs count of the ‘N’ vDUs is compared with maximum UE count capacity of ‘M’ vDUs, where M is less than N. This comparison is carried out to check whether the current load of the ‘N’ vDUs may be managed through a lesser number of vDUs. For example, the at least one processor may cause RIC 202 to carry out the above-mentioned comparison as discussed in above aspects.

At block 506, the method 500 may include selecting one or more vDUs among the at least two vDUs for serving at least two cells previously served by the at least two vDUs, if: the total PRB usage is less than the maximum available PRB for a predetermined time period, and the total connected UEs count is less than the maximum UE count capacity for the predetermined time period. The at least one processor may cause the RIC 202 to do the selection as discussed in above aspects. For example, if the total PRB usage of ‘N’ vDUs is less than the maximum available PRB of ‘M’ vDUs for a predetermined time period, and the total connected UEs count of ‘N’ vDUs is less than the maximum UE count capacity of ‘M’ vDUs for the predetermined time period, ‘M’ vDUs out of the ‘N’ vDUs are selected for serving the one or more cells previously served by the ‘N’ vDUs.

In one non-limiting aspect of the present disclosure, the step of selecting one or more vDUs among the at least two vDUs may include releasing one or more remaining vDUs, left after selecting the one or more vDUs, by barring an access to corresponding one or more cells through system information broadcast update and merging the at least two cells to form a merged cell, wherein the merged cell is served by the one or more vDUs being selected. Considering the example mentioned in above aspects, the remaining ‘N-M’ vDUs are released by barring an access to corresponding one or more cells. This may be carried out through cell barred or cell reservation technique. The selecting may further comprise merging at least two cells out of the ‘N’ cells to form a merged cell and the merged cell may be served by one of the selected ‘M’ vDUs.

In one non-limiting aspect of the present disclosure, the method 500 may include allocating one or more radio units (RUs) of the one or more remaining vDU to the one or more vDUs being selected. The step of allocating may also comprise updating a whitelist of the one or more vDUs by including serial numbers of the one or more RUs and deleting the serial numbers of the one or more RUs from one or more whitelists of the one or more remaining vDUs. Once the allocation is completed, the method 500 comprises terminating the one or more remaining vDUs. For example, the at least one processor may cause the RIC to allocate one or more radio units (RUs) of the ‘N-M’ vDUs to the one or more selected ‘M’ vDUs by updating a whitelist of the one or more selected vDUs i.e., ‘M’ vDUs to include serial numbers of the one or more RUs of the ‘N-M’ vDUs, and deleting the serial numbers of the one or more RUs from one or more whitelists of the ‘N-M’ vDUs to facilitate RU re-homing as discussed in above aspects. Once the RU of the ‘N-M’ vDUs are re-homed to one or more ‘M’ vDUs, the at least one processor may cause RIC to terminate the ‘N-M’ vDUs out of the ‘N’ existing vDUs.

Thus, the termination of one or more vDU facilitates freeing up of the computing resources of the cloud pool of the COTS server, thereby reducing the operational costs under low load condition. Further, the dynamic scaling of vDUs is done without invoking any RAN configuration change. In addition, the released vDU or computing resources may be used by any other gNB based on their capacity requirement.

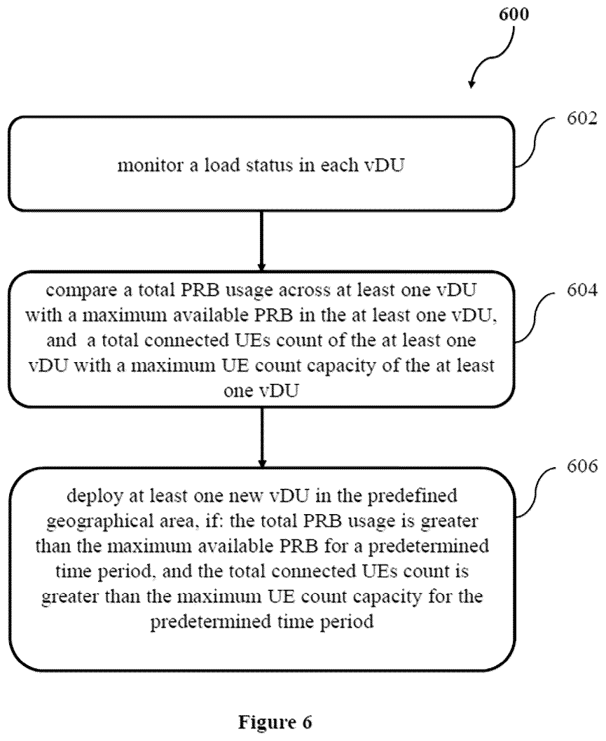

Referring now to FIG. 6, a flowchart is described illustrating yet another exemplary method 600 of dynamic vDU scaling during peak load scenario, according to an aspect of the present disclosure. The method 600 is merely provided for exemplary purposes, and aspects are intended to include or otherwise cover any load balancing methods or procedures.

The method 600 may include, at block 602, monitoring a load status in each vDU 212 and 214. The load status may comprise a PRB usage of each vDU and a UE count being served by each vDU 212 and 214. The load status of each of the vDU 212 and 214 may be monitored based on the periodic receipt of a plurality of parameters from the plurality of vDUs 212 and 214. The plurality of parameters may at least comprise PRB usage and connected UEs count.

At block 604, the method 600 may include comparing a total PRB usage across at least one vDU with a maximum available PRB in the at least one vDU and comparing a total connected UEs count of the at least one vDU with a maximum UE count capacity of the at least one vDU. The maximum available PRB and the maximum UE count capacity may be received from the respective vDU at the time of deployment. If there are ‘N’ number of vDUs currently present or deployed in a gNB, then the total PRB usage across ‘N’ vDUs is compared with maximum available PRB of ‘N’ vDUs and the total connected UEs count of the ‘N’ vDUs is compared with maximum UE count capacity of ‘N’ vDUs. This comparison is carried out to check whether the ‘N’ vDUs are overloaded or overburdened and whether there is a need to deploy an additional vDU for managing the load of the existing vDU of the gNB. For example, the at least one processor may cause RIC 202 to carry out the above-mentioned comparison.

At block 606, the method 600 may include deploying at least one new vDU in the same geographical area, if: the total PRB usage is greater than the maximum available PRB for a predetermined time period, and the total connected UEs count is greater than the maximum UE count capacity for the predetermined time period. The at least one processor may cause the RIC 202 to do the deployment through the VNF Manager 204. For example, if the total PRB usage of ‘N’ vDUs is greater than the maximum available PRB of ‘N’ vDUs for the predetermined time period, and the total connected UEs count of ‘N’ vDUs is less than the maximum UE count capacity of ‘N’ vDUs for the predetermined time period, then the one or more new vDUs may be newly deployed to share the load of the ‘N’ vDUs.

In one non-limiting aspect of the present disclosure, the step of deploying at least one new vDU in the same geographical area may include splitting at least one cell served by the at least one vDU to create at least one new cell and the at least one new cell is served by the at least one new vDU, thereby share the load of the existing vDUs.

In one non-limiting aspect of the present disclosure, the method 600 may include allocating one or more radio units (RUs) of the existing vDUs to the at least one new vDU. Considering the above example, one or more RUs of the ‘N’ vDUs may be allocated to the newly deployed vDU. The step of allocating may also comprise configuring a whitelist of the at least one new vDU by including serial numbers of the one or more RUs and deleting the serial numbers of the one or more RUs from a whitelist of the at least one vDU.

Thus, the deployment of the one or more new vDUs (computed resources hosted on COTS server 210) facilitates management of load or a capacity requirement during peak load condition, thereby ensuring quality of services for the user equipment served by the gNB.

The above methods 400, 500, 600 may be described in the general context of computer executable instructions. Generally, computer executable instructions can include routines, programs, objects, components, data structures, procedures, modules, and functions, which perform specific functions or implement specific abstract data types.

The various blocks of the methods 400, 500, 600 shown in FIGS. 4-6 have been arranged in a generally sequential manner for ease of explanation. However, it is to be understood that this arrangement is merely exemplary, and it should be recognized that the processing associated with methods 400, 500, 600 (and the blocks shown in FIGS. 4-6) can occur in a different order (for example, where at least some of the processing associated with the blocks is performed in parallel and/or in an event-driven manner). Additionally, individual blocks may be deleted from the methods without departing from the spirit and scope of the subject matter described herein. Furthermore, the methods can be implemented in any suitable hardware, software, firmware, or combination thereof.

The various operations of methods described above may be performed by any suitable means capable of performing the corresponding functions. The means may include various hardware and/or software component(s) and/or module(s). Generally, where there are operations illustrated in Figures, those operations may have corresponding counterpart means-plus-function components.

It may be noted here that the subject matter of some or all aspects described with reference to FIGS. 1, 2A, 2B, and 3 may be relevant for the methods and the same is not repeated for the sake of brevity.

In a non-limiting aspect of the present disclosure, one or more non-transitory computer-readable media may be utilized for implementing the aspects consistent with the present disclosure. A computer-readable media refers to any type of physical memory (such as the memory 310) on which information or data readable by a processor may be stored. Thus, a computer-readable media may store one or more instructions for execution by the at least one processor 308, including instructions for causing the at least one processor 308 to perform steps or stages consistent with the aspects described herein. The term “computer-readable media” should be understood to include tangible items and exclude carrier waves and transient signals. By way of example, and not limitation, such computer-readable media can comprise Random Access Memory (RAM), Read-Only Memory (ROM), volatile memory, nonvolatile memory, hard drives, Compact Disc (CD) ROMs, Digital Video Disc (DVDs), flash drives, disks, and any other known physical storage media.

Thus, certain non-limiting aspects may comprise a computer program product for performing the operations presented herein. For example, such a computer program product may comprise a computer readable media having instructions stored (and/or encoded) thereon, the instructions being executable by one or more processors to perform the operations described herein. For certain non-limiting aspects, the computer program product may include packaging material.

As used herein, a phrase referring to “at least one” or “one or more” of a list of items refers to any combination of those items, including single members. As an example, “at least one of: a, b, or c” is intended to cover: a, b, c, a-b, a-c, b-c, and a-b-c. The terms “a”, “an” and “the” mean “one or more”, unless expressly specified otherwise.

A description of an aspect with several components in communication with each other does not imply that all such components are required. On the contrary, a variety of optional components are described to illustrate the wide variety of possible aspects of the disclosed methods and systems.

Finally, the language used in the specification has been principally selected for readability and instructional purposes, and it may not have been selected to delineate or circumscribe the inventive subject matter. It is therefore intended that the scope of the disclosure be limited not by this detailed description, but rather by any claims that issue on an application based here on. Accordingly, the aspects of the present disclosure are intended to be illustrative, but not limiting, of the scope of the disclosure, which is set forth in the appended claims.

### Example Embodiments

Example 1 includes method comprising: monitoring a capacity requirement of a geographical area having a plurality of cells being served by a corresponding plurality of virtual Distributed Units (vDUs), wherein the capacity requirement comprises a Physical Resource Block (PRB) usage of the geographical area and a user equipment (UE) count being served in the geographical area; determining a number of vDUs required to cater the capacity requirement of the geographical area; and adjusting a count of the plurality of vDUs based on the number of vDUs required, wherein the adjusting comprises increasing or decreasing the count of the plurality of vDUs.

Example 2 includes the method of Example 1, wherein the decreasing the count of the plurality of vDUs comprises: monitoring a load status in each vDU, wherein the load status comprises a PRB usage of each vDU and a UE count being served by each vDU; comparing: a total PRB usage across at least two vDUs with a maximum available PRB in at least one vDU, and a total connected UEs count of the at least two vDUs with a maximum UE count capacity of the at least one vDU; and selecting one or more vDUs among the at least two vDUs for serving at least two cells previously served by the at least two vDUs, if: the total PRB usage is less than the maximum available PRB for a predetermined time period, and the total connected UEs count is less than the maximum UE count capacity for the predetermined time period.

Example 3 includes the method of Example 2, wherein selecting one or more vDUs among the at least two vDUs comprises: releasing one or more remaining vDUs, left after selecting the one or more vDUs, by barring an access to corresponding one or more cells through system information broadcast update; and merging the at least two cells to form a merged cell, wherein the merged cell is served by the one or more vDUs being selected.

Example 4 includes the method of any of Examples 2-3, further comprising: allocating one or more radio units (RUs) of the one or more remaining vDU to the one or more vDUs being selected, wherein allocating the one or more RUs comprises: updating a whitelist of the one or more vDUs by including serial numbers of the one or more RUs; and deleting the serial numbers of the one or more RUs from one or more whitelists of the one or more remaining vDUs.

Example 5 includes the method of any of Examples 2-4, further comprising: terminating the one or more remaining vDUs once the one or more RUs of the one or more remaining vDUs are allocated to the one or more vDUs being selected.

Example 6 includes the method of any of Examples 1-5, further comprising: periodically receiving a plurality of parameters from the plurality of vDUs, wherein the plurality of parameters at least comprise PRB usage, connected UEs count, and neighbour list.

Example 7 includes the method of any of Examples 1-6, wherein increasing the number of vDUs present in the geographical area comprises: monitoring a load status in each vDU, wherein the load status comprises a PRB usage of each vDU and a UE count being served by each vDU; comparing: a total PRB usage across at least one vDU with a maximum available PRB in the at least one vDU, and a total connected UEs count of the at least one vDU with a maximum UE count capacity of the at least one vDU; and deploying at least one new vDU in the geographical area, if: the total PRB usage is greater than the maximum available PRB for a predetermined time period, and the total connected UEs count is greater than the maximum UE count capacity for the predetermined time period.

Example 8 includes the method of Example 7, wherein deploying at least one new vDU in the geographical area comprises: splitting at least one cell served by the at least one vDU to create at least one new cell, wherein the at least one new cell is served by the at least one new vDU.

Example 9 includes the method of Example 8, further comprising: allocating one or more radio units (RUs) of the at least one vDU to the at least one new vDU, wherein allocating the one or more RUs comprises: configuring a whitelist of the at least one new vDU by including serial numbers of the one or more RUs; and deleting the serial numbers of the one or more RUs from a whitelist of the at least one vDU.

Example 10 includes the method of any of Examples 1-9, wherein each of the plurality of vDUs are hosted on a same commercial off the shelf (COTS) server.

Example 11 includes the method of any of Examples 1-10, wherein each of the plurality of vDUs are hosted on a different commercial off the shelf (COTS) server.

Example 12 includes the method of any of Examples 1-11, wherein the plurality of vDUs are deployed and configured by a virtual network function (VNF) manager.

Example 13 includes the method of any of Examples 1-12, further comprising: receiving physical cell ID (PCI), tracking area, maximum available PRBs, maximum connected UEs count, neighbour list, whitelist information from the plurality of vDU instances during deployment.

Example 14 includes an apparatus comprising: a memory; and at least one transceiver; and at least one processor communicatively coupled with the memory and the at least one transceiver, wherein the at least one processor is configured to: monitor a capacity requirement of a geographical area having a plurality of cells being served by a corresponding plurality of virtual Distributed Units (vDUs), wherein the capacity requirement comprises a Physical Resource Block (PRB) usage of the geographical area and a user equipment (UE) count being served in the geographical area, determine a number of vDUs required to cater the capacity requirement of the geographical area, and adjust a count of the plurality of vDUs based on the number of vDUs required by increasing or decreasing the count of the plurality of vDUs.

Example 15 includes the apparatus of Example 14, wherein to decrease the count of the plurality of vDUs, the at least one processor is configured to: monitor a load status in each vDU, wherein the load status comprises a PRB usage of each vDU and a UE count being served by each vDU, compare: a total PRB usage across at least two vDUs with a maximum available PRB in at least one vDU, and a total connected UEs count of the at least two vDUs with a maximum UE count capacity of the at least one vDU, and select one or more vDUs among the at least two vDUs for serving at least two cells previously served by the at least two vDUs if: the total PRB usage is less than the maximum available PRB for a predetermined time period, and the total connected UEs count is less than the maximum UE count capacity for the predetermined time period.

Example 16 includes the apparatus of Example 15, wherein to select one or more vDUs among the at least two vDUs, the at least one processor is configured to: release one or more remaining vDUs, left after selection the one or more vDUs, by barring an access to corresponding one or more cells through system information broadcast update, and merge the at least two cells to form a merged cell, wherein the merged cell is served by the one or more vDUs being selected.

Example 17 includes the apparatus of any of Examples 15-16, wherein the at least one processor is further configured to: allocate one or more radio units (RUs) of the one or more remaining vDU to the one or more vDUs being selected, wherein to allocate the one or more RUs, the at least one processor is further configured to: update a whitelist of the one or more vDUs to include serial numbers of the one or more RUs; and delete the serial numbers of the one or more RUs from one or more whitelists of the one or more remaining vDUs.

Example 18 includes the apparatus of any of Examples 15-16, wherein the at least one processor is further configured to: terminate the one or more remaining vDUs once the one or more RUs of the one or more remaining vDUs are allocated to the one or more vDUs being selected.

Example 19 includes the apparatus of any of Examples 14-18, wherein the at least one transceiver is configured to: periodically receive a plurality of parameters from the plurality of vDUs, wherein the plurality of parameters at least comprise PRB usage, connected UEs count, and neighbour list.

Example 20 includes the apparatus of any of Examples 14-19, wherein to increase the number of vDUs present in the geographical area, the at least one processor is configured to: monitor a load status in each vDU, wherein the load status comprises a PRB usage of each vDU and a UE count being served by each vDU, compare: a total PRB usage across at least one vDU with a maximum available PRB in the at least one vDU, and a total connected UEs count of the at least one vDU with a maximum UE count capacity of the at least one vDU; and deploy at least one new vDU in the geographical area, if: the total PRB usage is greater than the maximum available PRB for a predetermined time period, and the total connected UEs count is greater than the maximum UE count capacity for the predetermined time period.

Example 21 includes the apparatus of Example 20, wherein to deploy at least one new vDU in the geographical area, the at least one processor is configured to: split at least one cell served by the at least one vDU to create at least one new cell, wherein the at least one new cell is served by the at least one new vDU.

Example 22 includes the apparatus of any of Examples 20-21, wherein the at least one processor is further configured to: allocate one or more radio units (RUs) of the at least one vDU to the at least one new vDU, wherein allocating the one or more RUs comprises: configure a whitelist of the at least one new vDU to include serial numbers of the one or more RUs; and delete the serial numbers of the one or more RUs from a whitelist of the at least one vDU.

Example 23 includes the apparatus of any of Examples 14-22, wherein each of the plurality of vDUs are hosted on a same commercial off the shelf (COTS) server.

Example 24 includes the apparatus of any of Examples 14-23, wherein each of the plurality of vDUs are hosted on a different commercial off the shelf (COTS) server.

Example 25 includes the apparatus of any of Examples 14-24, wherein the plurality of vDUs are deployed and configured by a virtual network function (VNF) manager.

Example 26 includes the apparatus of any of Examples 14-25, wherein the at least one transceiver is configured to: receive physical cell ID (PCI), tracking area, maximum available PRBs, maximum connected UEs count, neighbour list, whitelist information from the plurality of vDU during deployment.

Example 27 includes a non-transitory computer-readable medium having computer-readable instructions that when executed by at least one processor causes the at least one processor to perform operations of: monitoring a capacity requirement of a geographical area having a plurality of cells being served by a corresponding plurality of virtual Distributed Units (vDUs), wherein the capacity requirement comprises Physical Resource Block (PRB) usage of the geographical area and user equipment (UE) count being served in the geographical area; determining a number of vDUs required to cater the capacity requirement of the geographical area; and adjusting a count of the plurality of VDUs based on the number of vDUs required, wherein the adjusting comprises increasing or decreasing the count of the plurality of vDUs.

What is claimed is:

1. A method comprising:
monitoring a capacity requirement of a geographical area having a plurality of cells being served by a corresponding plurality of virtual Distributed Units (vDUs), wherein the capacity requirement comprises a Physical Resource Block (PRB) usage of the geographical area and a user equipment (UE) count being served in the geographical area;
determining a number of vDUs required to cater the capacity requirement of the geographical area; and
adjusting a count of the plurality of vDUs based on the number of vDUs required, wherein the adjusting comprises increasing or decreasing the count of the plurality of vDUs.

2. The method of claim 1, wherein the decreasing the count of the plurality of vDUs comprises:
monitoring a load status in each vDU, wherein the load status comprises a PRB usage of each vDU and a UE count being served by each vDU;
comparing:
a total PRB usage across at least two vDUs with a maximum available PRB in at least one vDU, and
a total connected UEs count of the at least two vDUs with a maximum UE count capacity of the at least one vDU; and
selecting one or more vDUs among the at least two vDUs for serving at least two cells previously served by the at least two vDUs, if:
the total PRB usage is less than the maximum available PRB for a predetermined time period, and
the total connected UEs count is less than the maximum UE count capacity for the predetermined time period.

3. The method of claim 2, wherein selecting one or more vDUs among the at least two vDUs comprises:
releasing one or more remaining vDUs, left after selecting the one or more vDUs, by barring an access to corresponding one or more cells through system information broadcast update; and
merging the at least two cells to form a merged cell, wherein the merged cell is served by the one or more vDUs being selected.

4. The method of claim 2, further comprising:
allocating one or more radio units (RUs) of the one or more remaining vDU to the one or more vDUs being selected, wherein allocating the one or more RUs comprises:
updating a whitelist of the one or more vDUs by including serial numbers of the one or more RUs; and
deleting the serial numbers of the one or more RUs from one or more whitelists of the one or more remaining vDUs.

5. The method of claim 2, further comprising:
terminating the one or more remaining vDUs once the one or more RUs of the one or more remaining vDUs are allocated to the one or more vDUs being selected.

6. The method of claim 1, further comprising:
periodically receiving a plurality of parameters from the plurality of vDUs, wherein the plurality of parameters at least comprise PRB usage, connected UEs count, and neighbour list.

7. The method of claim 1, wherein increasing the number of vDUs present in the geographical area comprises:
monitoring a load status in each vDU, wherein the load status comprises a PRB usage of each vDU and a UE count being served by each vDU;
comparing:
a total PRB usage across at least one vDU with a maximum available PRB in the at least one vDU, and
a total connected UEs count of the at least one vDU with a maximum UE count capacity of the at least one vDU; and
deploying at least one new vDU in the geographical area, if:
the total PRB usage is greater than the maximum available PRB for a predetermined time period, and
the total connected UEs count is greater than the maximum UE count capacity for the predetermined time period.

8. The method of claim 7, wherein deploying at least one new vDU in the geographical area comprises:
splitting at least one cell served by the at least one vDU to create at least one new cell, wherein the at least one new cell is served by the at least one new vDU.

9. The method of claim 8, further comprising:
allocating one or more radio units (RUs) of the at least one vDU to the at least one new vDU, wherein allocating the one or more RUs comprises:
configuring a whitelist of the at least one new vDU by including serial numbers of the one or more RUs; and
deleting the serial numbers of the one or more RUs from a whitelist of the at least one vDU.

10. The method of claim 1, wherein each of the plurality of vDUs are hosted on a same commercial off the shelf (COTS) server.

11. The method of claim 1, wherein each of the plurality of vDUs are hosted on a different commercial off the shelf (COTS) server.

12. The method of claim 1, wherein the plurality of vDUs are deployed and configured by a virtual network function (VNF) manager.

13. The method of claim 1, further comprising:
receiving physical cell ID (PCI), tracking area, maximum available PRBs, maximum connected UEs count, neighbour list, whitelist information from the plurality of vDU instances during deployment.

14. An apparatus comprising:
a memory; and
at least one transceiver; and
at least one processor communicatively coupled with the memory and the at least one transceiver, wherein the at least one processor is configured to:
monitor a capacity requirement of a geographical area having a plurality of cells being served by a corresponding plurality of virtual Distributed Units (vDUs), wherein the capacity requirement comprises a Physical Resource Block (PRB) usage of the geographical area and a user equipment (UE) count being served in the geographical area,
determine a number of vDUs required to cater the capacity requirement of the geographical area, and
adjust a count of the plurality of vDUs based on the number of vDUs required by increasing or decreasing the count of the plurality of vDUs.

15. The apparatus of claim 14, wherein to decrease the count of the plurality of vDUs, the at least one processor is configured to:
monitor a load status in each vDU, wherein the load status comprises a PRB usage of each vDU and a UE count being served by each vDU,
compare:
a total PRB usage across at least two vDUs with a maximum available PRB in at least one vDU, and
a total connected UEs count of the at least two vDUs with a maximum UE count capacity of the at least one vDU, and
select one or more vDUs among the at least two vDUs for serving at least two cells previously served by the at least two vDUs if:
the total PRB usage is less than the maximum available PRB for a predetermined time period, and
the total connected UEs count is less than the maximum UE count capacity for the predetermined time period.

16. The apparatus of claim 15, wherein to select one or more vDUs among the at least two vDUs, the at least one processor is configured to:
release one or more remaining vDUs, left after selection the one or more vDUs, by barring an access to corresponding one or more cells through system information broadcast update, and
merge the at least two cells to form a merged cell, wherein the merged cell is served by the one or more vDUs being selected.

17. The apparatus of claim 15, wherein the at least one processor is further configured to:
allocate one or more radio units (RUs) of the one or more remaining vDU to the one or more vDUs being selected, wherein to allocate the one or more RUs, the at least one processor is further configured to:
update a whitelist of the one or more vDUs to include serial numbers of the one or more RUs; and
delete the serial numbers of the one or more RUs from one or more whitelists of the one or more remaining vDUs.

18. The apparatus of claim 15, wherein the at least one processor is further configured to:
terminate the one or more remaining vDUs once the one or more RUs of the one or more remaining vDUs are allocated to the one or more vDUs being selected.

19. The apparatus of claim 14, wherein the at least one transceiver is configured to:
periodically receive a plurality of parameters from the plurality of vDUs, wherein the plurality of parameters at least comprise PRB usage, connected UEs count, and neighbour list.

20. The apparatus of claim 14, wherein to increase the number of vDUs present in the geographical area, the at least one processor is configured to:
monitor a load status in each vDU, wherein the load status comprises a PRB usage of each vDU and a UE count being served by each vDU,
compare:
a total PRB usage across at least one vDU with a maximum available PRB in the at least one vDU, and
a total connected UEs count of the at least one vDU with a maximum UE count capacity of the at least one vDU; and
deploy at least one new vDU in the geographical area, if:
the total PRB usage is greater than the maximum available PRB for a predetermined time period, and
the total connected UEs count is greater than the maximum UE count capacity for the predetermined time period.

21. The apparatus of claim 20, wherein to deploy at least one new vDU in the geographical area, the at least one processor is configured to:
split at least one cell served by the at least one vDU to create at least one new cell, wherein the at least one new cell is served by the at least one new vDU.

22. The apparatus of claim 20, wherein the at least one processor is further configured to:
allocate one or more radio units (RUs) of the at least one vDU to the at least one new vDU, wherein allocating the one or more RUs comprises:
configure a whitelist of the at least one new vDU to include serial numbers of the one or more RUs; and
delete the serial numbers of the one or more RUs from a whitelist of the at least one vDU.

23. The apparatus of claim 14, wherein each of the plurality of vDUs are hosted on a same commercial off the shelf (COTS) server.

24. The apparatus of claim 14, wherein each of the plurality of vDUs are hosted on a different commercial off the shelf (COTS) server.

25. The apparatus of claim 14, wherein the plurality of vDUs are deployed and configured by a virtual network function (VNF) manager.

26. The apparatus of claim 14, wherein the at least one transceiver is configured to:
receive physical cell ID (PCI), tracking area, maximum available PRBs, maximum connected UEs count, neighbour list, whitelist information from the plurality of vDU during deployment.

27. A non-transitory computer-readable medium having computer-readable instructions that when executed by at least one processor causes the at least one processor to perform operations of:
monitoring a capacity requirement of a geographical area having a plurality of cells being served by a corresponding plurality of virtual Distributed Units (vDUs), wherein the capacity requirement comprises Physical Resource Block (PRB) usage of the geographical area and user equipment (UE) count being served in the geographical area;
determining a number of vDUs required to cater the capacity requirement of the geographical area; and
adjusting a count of the plurality of VDUs based on the number of vDUs required, wherein the adjusting comprises increasing or decreasing the count of the plurality of vDUs.
